(19) United States
(12) Patent Application Publication
(10) Pub. No.: US 2015/0137573 A1
(43) Pub. Date: May 21, 2015

(54) Travel Pillow

(71) Applicant: Ryan A. Winn, Virginia Beach, VA (US)

(72) Inventor: Ryan A. Winn, Virginia Beach, VA (US)

(21) Appl. No.: 14/509,367

(22) Filed: Oct. 8, 2014

Related U.S. Application Data
(60) Provisional application No. 61/906,202, filed on Nov. 19, 2013.

(51) Int. Cl. B60N 2/48; A47C 7/38; A47G 9/10

(52) U.S. Cl. CPC B60N 2/4879; A47G 9/10; A47C 7/383
USPC 297/393; 297/391

(57) ABSTRACT

A travel pillow that assists in maintaining an upright and healthy posture while sleeping in public or private transportation. The pillow is an elongated plush, padded fabric tubular body filled with padding material. The pillow has flexible sewn pleats as folding points. The pillow wraps around a user's neck and body, and is held in place by hook-and-loop strips. The pillow also has a button shank and corresponding button loop so that the pillow may be rolled for carrying and storage, the button loop and button shank holding the pillow in a rolled configuration.

### BACKGROUND OF THE INVENTION

Keeping an upright and comfortable posture while sitting can be problematic depending upon the individual as well as environmental circumstances. Medical conditions and aging may cause discomfort for many people as they sit and, more importantly, travel. Being seated in a cramped passenger cabin on an aircraft or other public transit can be extremely uncomfortable and even dangerous. It is also common for people to sleep while flying or using other public transit, but while sleeping sitting upright it is common for people to slump over, either forwards or to one side. The same thing can occur when riding in a car or some other personal transportation. This can be uncomfortable and, in some cases, be dangerous to a person's health.

Various travel pillows have been proposed or are currently being sold. None of the designs currently available, however, can assist in maintaining an upright and healthy posture while sleeping in public or private transportation. What is needed is a pillow that not only provides comfort to a traveler, but also allows the user to fall asleep comfortably while still having a beneficial upright posture. What is also needed is a travel pillow that is versatile enough to be used with any chair, such as at home, the office, etc. Such a pillow should be comfortable enough to support a person taking short “power” naps as well.

It is therefore an object of the present invention to provide a travel pillow that assists in maintaining an individual's upright and healthy posture while sleeping in public or private transportation.

It is a further object of the present invention to provide a pillow that not only provides comfort to a traveler, but also allows the user to fall asleep comfortably while still having a beneficial upright posture.

It is a further object of the present invention to provide a travel pillow that is versatile enough to be used with any chair, such as at home, the office, etc. Such a pillow should be comfortable enough to support a person taking short “power” naps as well.

It is a further object of the present invention to provide a travel pillow that can be utilized to add a plush, cozy feel to any chair.

### BRIEF DESCRIPTION OF THE DRAWINGS

FIG. 1 is front view of an embodiment of the present invention.

FIG. 2 is a view of an embodiment of the present invention while in use.

FIG. 3 is a view of an embodiment of the present invention in a compact, rolled-up configuration.

### DETAILED DESCRIPTION OF THE INVENTION

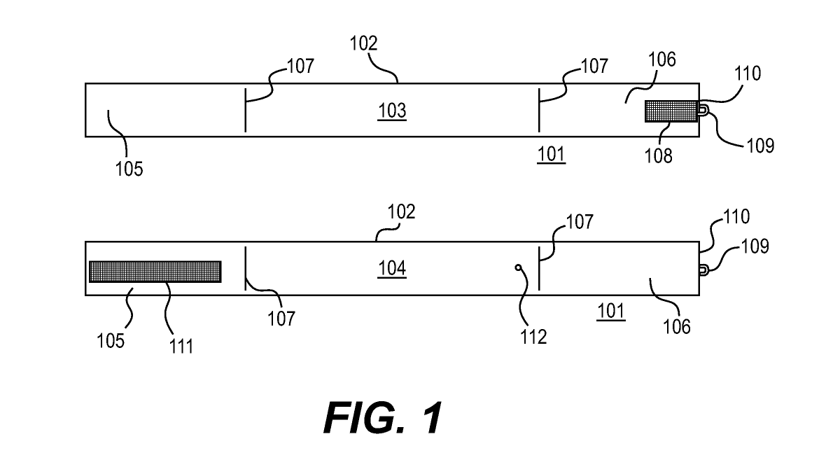

Referring now to FIG. 1, the pillow 101 comprised of an elongated plush, padded fabric tubular body center portion 102 with a first side 103 and a second side 104, and a first end 105 and a second end 106. The center portion 102 is filled with padding material (not shown) and is separated from the first end 105 and the second end 106 by sewn pleats 107, which provide for flexible folding points. The first end 105 and second end 106 are comprised of the same plush material as the center portion 102, but the padding of the center portion 102 is isolated from the ends 105 and 106 by the sewn pleats 107. The sewn pleats 107 also function as flexible folding points for the pillow. It will be understood that the ends 105 and 106 may also comprise padding, and that inner padding of both the center portion 102 and the ends 105 and 106 may comprise a single piece of material as well as individual pieces for the center portion 102 and the ends 105 and 106 respectively. For ease of construction, a single piece of padding is used and the sewn pleats 107 comprise thread sewn through the plush fabric covering of the pillow 101.

On the first side 103 of the second end 106 is incorporated at hook-and-loop strip 108, which is sewn in place but may be attached by any means known for attaching hook-and-loop material. The second end 106 further includes a loop 109 attached at the outside, narrow edge 110 of the second end 106. The second side 104 incorporates a hook-and-loop strip 111, which is attached in the same or similar manner as the hook-and-loop strip 108, and is attached on the first end 105. The second side 104 further includes a button shank 112, which is affixed to the center portion 102. The plush fabric of the pillow 101 may be chosen from any material suitable for the purpose described herein but is preferentially of a soft, washable fabric that is comfortable and washable. The materials chosen may also be hypoallergenic. The padding material may be chosen from any well-known padding materials such as batting (rolled into a tube for the filling), and of either natural materials, such as down, or from artificial materials such as polyester and is preferentially a soft-napped material for comfort.

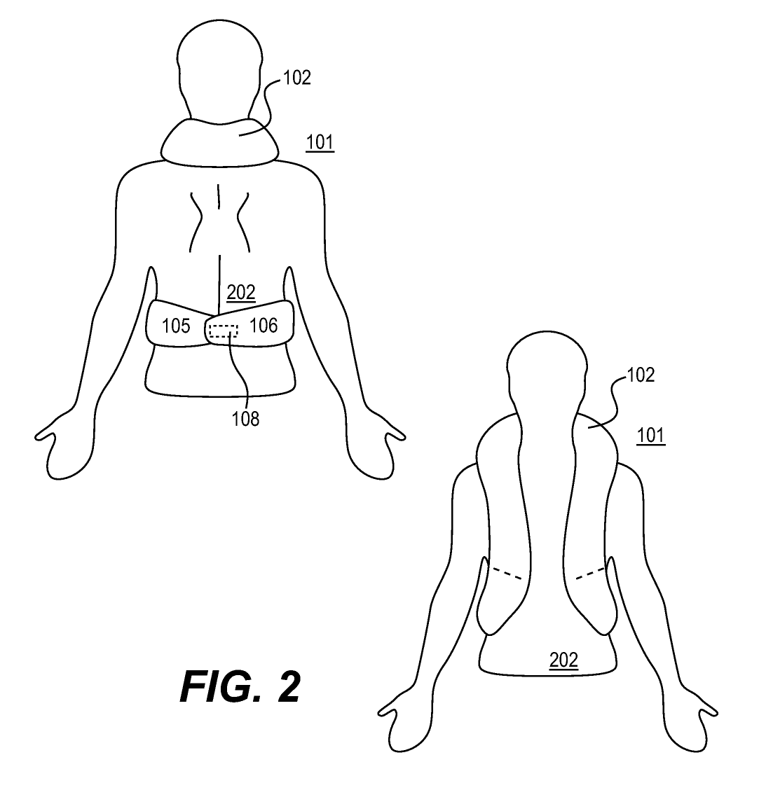

Referring now to FIG. 2, an embodiment of the present invention is shown while in use. The pillow 101 is shown being worn by a user 202. The pillow 101 wraps around a user's neck at the center portion 102, with the pillow 101 draped down the front of the user, and wrapped around the user's waist. The pillow 101 ends 105 and 106 overlap so that the hook-and-loop strip 108 on the end 106 attaches to the hook-and-loop strip (FIG. 1, 111—not shown in FIG. 2) on end 105, thus securing the pillow in place.

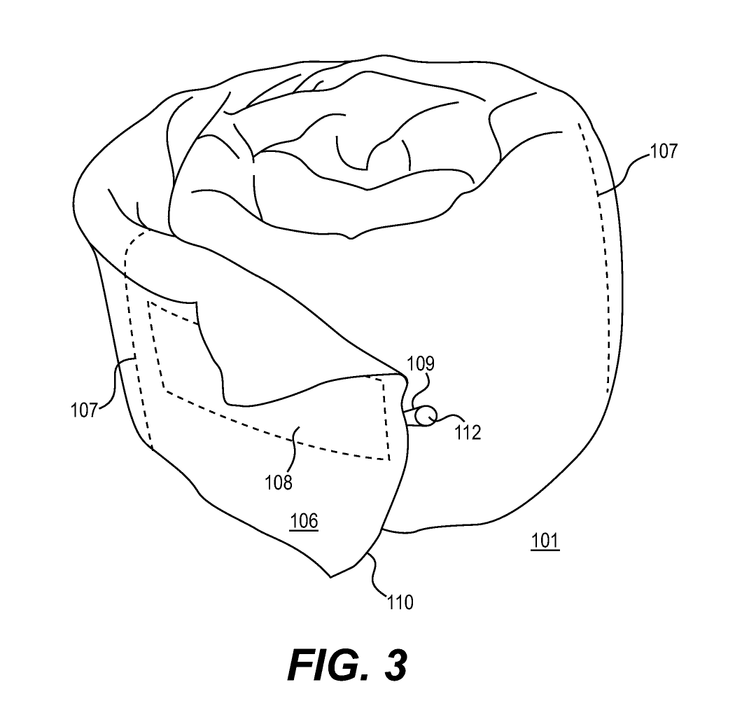

Referring now to FIG. 3, the pillow 101 is shown in a stowage configuration. The pillow 101 is rolled around on itself, the loop 109 attached at the outside, narrow edge 110 of the second end 106 is looped around the button shank 112, with the hook-and-loop strip 108 on the inside of the end 106 so that it doesn't catch on fabric or other items while the pillow is stowed.

1. A pillow comprising:
an elongated plush, padded fabric tubular body center portion;
a first side;
a second side;
a first end terminating in a narrow outside edge; and
a second end terminating in a narrow outside edge.

2. The pillow of claim 1 wherein the center portion is filled with padding material, and the center portion is separated from the first end and the second end by sewn pleats.

3. The pillow of claim 2 wherein the sewn pleats are flexible folding points.

4. The pillow of claim 2 wherein the first end and second end are comprised of the same plush material as the center portion and the padding of the center portion is isolated from the first end and the second end by the sewn pleats.

5. The pillow of claim 2 wherein the first end and the second end contain inner padding.

6. The pillow of claim 5 wherein the inner padding of both the center portion and the first end and the second end comprise a single piece of material.

7. The pillow of claim 2 wherein the first side of the second end has a hook-and-loop strip affixed to the first side, and the second side of the first end has a hook-and-loop strip affixed to the second side.

8. The pillow of claim 7 wherein the pillow is configured to drape around the back of a user's neck, the first end and second end wrapping down the left and right side of a user's torso and around a user's waist, the hook-and-loop strip affixed to the first side and the hook-and-loop strip affixed to the second side overlapping on a user's back such that the hook-and-loop strips attached to each other and hold the pillow in place on the user's body.

9. The pillow of claim 2 wherein the pillow has a loop attached at the narrow outside edge of the second end, and the second side has a button shank affixed to the center portion.

10. The pillow of claim 9 wherein the pillow is configured such that it may be rolled around on itself, the button shank being placed through the loop thereby holding the pillow in a rolled configuration.

11. A pillow comprising:
an elongated plush, padded fabric tubular body center portion filled with padding material;
a first side;
a second side;
a first end containing inner padding and terminating in a narrow outside edge separated from the center portion by a sewn pleat;
a second end containing inner padding and terminating in a narrow outside edge wherein the second end is separated from the center portion by a sewn pleat;
the first end and second end are comprised of the same plush material as the center portion and the padding of the center portion is isolated from the first end and the second end by the sewn pleats;
the first side of the second end has a hook-and-loop strip affixed to the first side, and the second side of the first end has a hook-and-loop strip affixed to the second side;
a loop is attached at the narrow outside edge of the second end and the second side; and
a button shank is affixed to the center portion.

12. The pillow of claim 11 wherein the pillow is configured to drape around the back of a user's neck, the first end and second end wrapping down the left and right side of a user's torso and around a user's waist, the hook-and-loop strip affixed to the first side and the hook-and-loop strip affixed to the second side overlapping on a user's back such that the hook-and-loop strips attached to each other and hold the pillow in place on the user's body.

13. The pillow of claim 11 wherein the pillow is configured such that it may be rolled around on itself, the button shank being placed through the loop thereby holding the pillow in a rolled configuration.
